(19) United States
(12) Patent Application Publication
(10) Pub. No.: US 2010/0224695 A1
(43) Pub. Date: Sep. 9, 2010

(54) CONTROLLING IONIZATION SOURCE TEMPERATURE

(75) Inventors: Ching Wu, Acton, MA (US); Mark A. Osgood, Brookline, NH (US); Christopher Hilton, Acton, MA (US)

Correspondence Address: CHING WU;Excellims Corporation, 20 Main Street, Acton, MA, 01720, US

(73) Assignee: Excellims Corporation, Acton, MA (US)

(21) Appl. No.: 12/719,831

(22) Filed: Mar. 8, 2010

Related U.S. Application Data
(60) Provisional application No. 61/158,395, filed on Mar. 8, 2009.

(51) Int. Cl. B05B 5/025

(52) U.S. Cl. 239/3; 239/690

(57) ABSTRACT

The present invention is a method and apparatus to keep the electrospray ionization at a lower temperature than the heated chamber where the desolvation process occurs. The means to cool the electrosprayer is by actively removing heat from the apparatus through heat transfer methods. This apparatus and method can be used with any ionization apparatus at high temperatures preventing the ionization source from reaching a high temperature that may hinter the normal operation.

### CROSS-REFERENCE TO RELATED APPLICATIONS

The present application claims the benefit of and priority to corresponding U.S. Provisional Patent Application No. 61/158,395, filed Mar. 8, 2009 respectively, the entire content of the application is herein incorporated by reference.

### BACKGROUND OF THE INVENTION

Electrospray ionization (ESI) is a technique used in mass spectrometry and ion mobility spectrometry (IMS) to produce ions. It is especially useful in producing ions from macromolecules and it overcomes the propensity of these molecules to fragment when ionized. In electrospray ionization, a liquid is normally delivered through an element, such as a capillary, that has a different electrical potential from surrounding electrodes. The liquid contains the analyte compounds and an excess of volatile solvent. The compound exists as an ion in solution either in its anion or cation form. The liquid pushes itself out of the capillary and forms an aerosol because like charges repel each other. A neutral carrier gas can be used to help nebulize the liquid. As the solvent evaporates, the molecules go through Coulombic fission until the compound is free of solvent and is a lone ion. Acid or other components can be added to adjust the pH and help stabilize the charge.

When using ESI with mass spectrometry, a vacuum system is commonly used to assist the desolvation process. On, the contrary, an IMS system is typically at atmospheric pressure when ESI is used. ESI that is performed under atmospheric pressure needs a heat source to fully desolvate ions. This is performed by heating the drift gas for IMS or the nebulizing gas, the capillary inlet, or curtain gas for MS. The most commonly used electrospray method is to electrospray into a chamber which is at a lower temperature than the ESI source. The present invention electrosprays into an already heated chamber (reaction region/desolvation region of IMS). In order to stabilize the electrosprayer and control the desolvation process of the electrospray, we have invented a method and apparatus to keep the electrosprayer at a lower temperature than the heated chamber (reaction region/desolvation region). The method and apparatus of cooling limits the sample from crashing out (crystallizing) in the electrosprayer and/or on the electrosprayer tip.

### SUMMARY OF THE INVENTION

One aspect of the present invention is a method and apparatus to keep the electrospray ionization at a lower temperature than the heated chamber where the desolvation process occurs. The method and apparatus of cooling prevents the sample from crashing out (crystallizing) in the electrosprayer or on the electrosprayer tip. The means to cool the electrosprayer is by actively removing heat from the apparatus through convection and/or conduction heat transfer methods, but are not limited to only these.

An embodiment of the invention uses aluminum nitrite (AlN) bridge with a cooling apparatus, in particular, a heat sink in-conjunction with a fan. This apparatus and method can be used with any ionization apparatus at high temperatures, such as 100-300° C., preventing the electrosprayer from reaching a high temperature that may cause solvent evaporation in the electrosprayer.

### BRIEF DESCRIPTION OF THE DRAWINGS

The foregoing and other aspects, embodiments, and features of the inventions can be more fully understood from the following description in conjunction with the accompanying drawings. In the drawings like reference characters generally refer to like features and structural elements throughout the various figures. The drawings are not necessarily to scale, emphasis instead being placed upon illustrating the principles of the inventions.

FIG. 1 shows a electrospray ionization apparatus.

FIG. 2 shows capillary section configurations 200a, 220b, and various embodiments of the spraying end of the electrospray ionization apparatus.

FIG. 3 shows an embodiment of the electrospray ionization apparatus using a conductive and non-conductive material that comprises the sheath enclosing the capillary.

FIG. 4 shows one means for cooling the electrospray ionization apparatus.

### DETAILED DESCRIPTION OF VARIOUS EMBODIMENTS

Unless otherwise specified in this document the term “ion mobility based spectrometer” is intended to mean any device that separates ions based on their ion mobilities and/or mobility differences under the same or different physical and/or chemical conditions, the spectrometer may also include detecting the ions after the separation process. Many embodiments herein use the time of flight type IMS as examples; the term ion mobility based spectrometer shall also include many other kinds of spectrometers, such as differential mobility spectrometer (DMS) and field asymmetric ion mobility spectrometer (FAIMS). Unless otherwise specified, the term ion mobility spectrometer or IMS is used interchangeable with the term ion mobility based spectrometer defined above.

As used herein, the term “analytical instrument” generally refers to ion mobility based spectrometer, MS, and any other instruments that have the same or similar functions. Unless otherwise specified in this document the term “mass spectrometer” or MS is intended to mean any device or instrument that measures the mass to charge ratio of a chemical/biological molecules that have been converted to an ion or stores ions with the intention to determine the mass to charge ratio at a later time. Examples of MS include, but are not limited to: an ion trap mass spectrometer (ITMS), a time of flight mass spectrometer (TOFMS), and MS with one or more quadrupole mass filters

The phrase “and/or,” as used herein in the specification and in the claims, should be understood to mean “either or both” of the elements so conjoined, i.e., elements that are conjunctively present in some cases and disjunctively present in other cases.

Unless otherwise specified in this document the term “chemical and/or biological molecule” is intended to mean single or plurality of particles that are, either charged or not charge, derived from atoms, molecules, particles, and sub-atomic particles.

FIG. 1 shows an example of an electrospray ionization apparatus, sometimes referred to as an electrosprayer. During electrospray ionization, a liquid is pushed through a charged (with a high voltage applied) capillary section 109. The sample 102 is introduced from one end of the capillary section 101 and produces ions near the other end of the capillary section 103. A high voltage is applied between the capillary section 109 and a counter electrode (not shown) to produce a strong electric field. The sample in the capillary section 109 is electrostatically sprayed and disperses as charged liquid droplets. A structure with greater internal diameter can be used as the sheath 105 that encloses the capillary section. The sheath can be maintained at a given temperature, thus the electrosprayer in the capillary section can be isolated from the surrounding environment. The electrosprayer may or may not be in direct contact with the sheath; preferably, in direct contact to the sheath, whereby controlling the temperature enbles the electrospray to occur at similar temperatures.

In many embodiments, the electrosprayer refers to a device that is used to generate electrosprayed ions. It could be as simple as using a capillary tube, the tube could be dielectric or conductive. In the case of using a dielectric tube, the electrospray high voltage is common applied to the sample solution. For a conductive tube, the voltage is directly applied to the tube structure. The electrosprayer can have a rather complex structure to assist the formation of the ions. In this invention, the term electrosprayer refers to the state of the art of electrospray apparatuses for ion mobility spectrometers and mass spectrometers in its broadest meaning. The electrospray ionization apparatus can have an electrosprayer and a heat exchanger that is in direct contact to the electrosprayer through one or more contact points in order to transfer thermal energy, thereby controlling the electrosprayer at a given temperature that the experimentalist would like to ionize some of the supplied sample. In addition, a sheath can be placed around the electrosprayer. There can be various configurations for the apparatus. For example, the electrosprayer can be in direct contact with the sheath through one or more contact points and/or the sheath is in direct contact to the heat exchanger.

The term heat exchanger in this invention generally refers to a mechanical structure that allows efficient heat exchange. In many embodiments, the heat exchanger has a larger surface area for fast heat transfer in or out of the mechanical structure. The heat exchanger can be active or passive. The active heat exchanger uses other means to accelerate heat transfer from/to the structure. For example, a fan is commonly used to blow onto the exchanger to remove heat from the structure. A passive heat exchanger relies on natural heat exchange, such as a convection flow between the structure and surrounding media, such as, air, liquid, etc. The heat exchanger is sometimes referred to as a heat sink in this invention.

In a variety of embodiments, the material of the sheath 105 around the capillary section 109 as shown in FIG. 1 can be made from any kind of metals, Aluminium nitride (AIN), Boron nitride, Aluminium phosphide, Induim nitride, alumina, BeO, metals, metalloids, alkaline earth metals, lanthanides, actinides, and transition elements. When the sheath 105 is made of metal, additional technical approach is necessary when electrosprayer is not operated under ground potential. The sheath can be made from one or more layers of material.

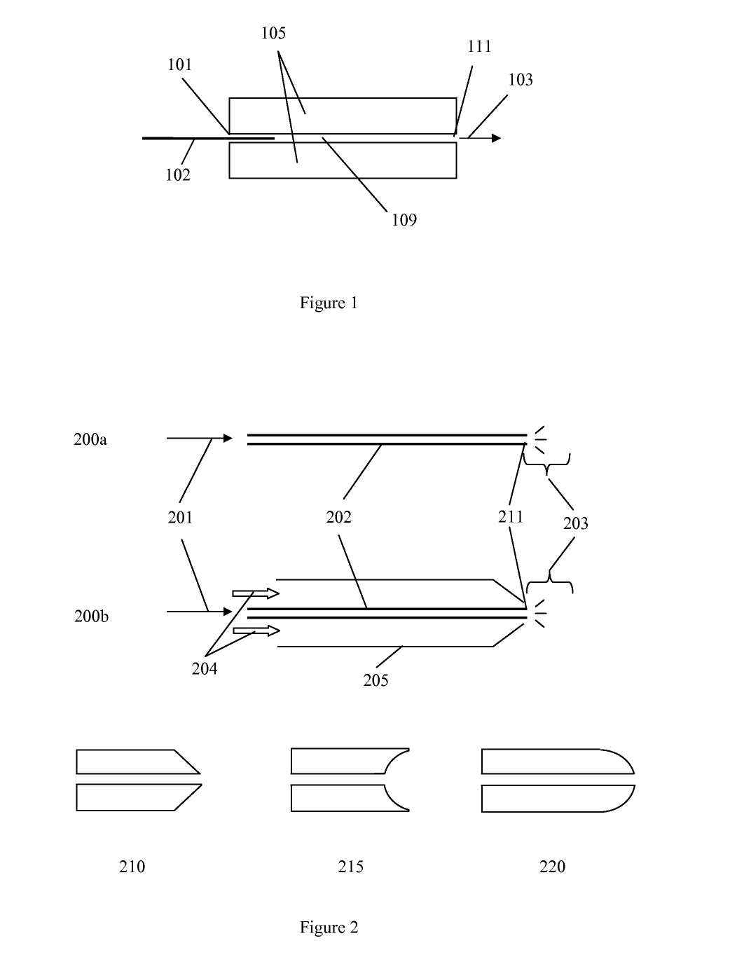

FIG. 2 shows a non-limiting embodiment of the capillary section; configurations 200a and 200b. The capillary section can simply be capillary tubing that accommodates an applied high voltage to the sample in order to generate electrosprayed ions. Therefore, the electrosprayer can simply be a capillary tube. The capillary tubing could be made of: metal, silica, ceramic, metalized dielectric material, or other materials/structures that could deliver liquid in a narrow bore stream. In the configuration 200a, a liquid sample 201 is delivered to one end of the capillary tubing 202, applying a high voltage to the sample, capillary tubing inside or outside the capillary section of the electrosprayer, and producing ions near the other end of the capillary section 203. For the electrosprayer, a counter electrode, may or may not be employed. In the case of not designating a counter electrode, the nearby electrodes will help define the electric field configuration around the electrosprayer. The sample in the capillary 202 is electrostatically sprayed and disperses as charged liquid droplets.

In an alternative embodiment, the capillary section could include a rather complex structure. Configuration 200b illustrates a capillary section that has a pneumatic electrosprayer where a capillary tubing and an outer structure 205 allows nebulizing the liquid sample during electrospray process. A liquid sample 201 is delivered to one end of the inner capillary tubing 202, a high voltage is applied to the sample and/or the capillary tubing inside; and charged droplets are formed in a region 203 near to the other end of the capillary section 211 producing ions of samples. In addition, gas flow 204 is also introduced to the electrosprayer to assist in formation of the charged droplet. The nebulizing electrosprayer is commonly used for samples with higher flow rates.

In all of the embodiments of this invention, the end of the electrospray ionization apparatus where the spray is formed 111 or 211 can be shaped in a manner to optimize ion formation. As shown in FIG. 2, the end can be curved to provide a region of relatively uniform spray, such as a sharp feature 210, a concave feature 215, a convex feature 220, but not limited to only these shapes.

The proposed electrospray ionization apparatus can be used in any instrument in which it is necessary to produce ions for the instrument's use, such as a mass spectrometer and/or an ion mobility spectrometer. In particular, the proposed electrospray ionization apparatus is useful for instruments that are being used at atmospheric pressure or near atmospheric pressure and need to keep the electrospray ionization at a lower temperature than the rest of the instrument.

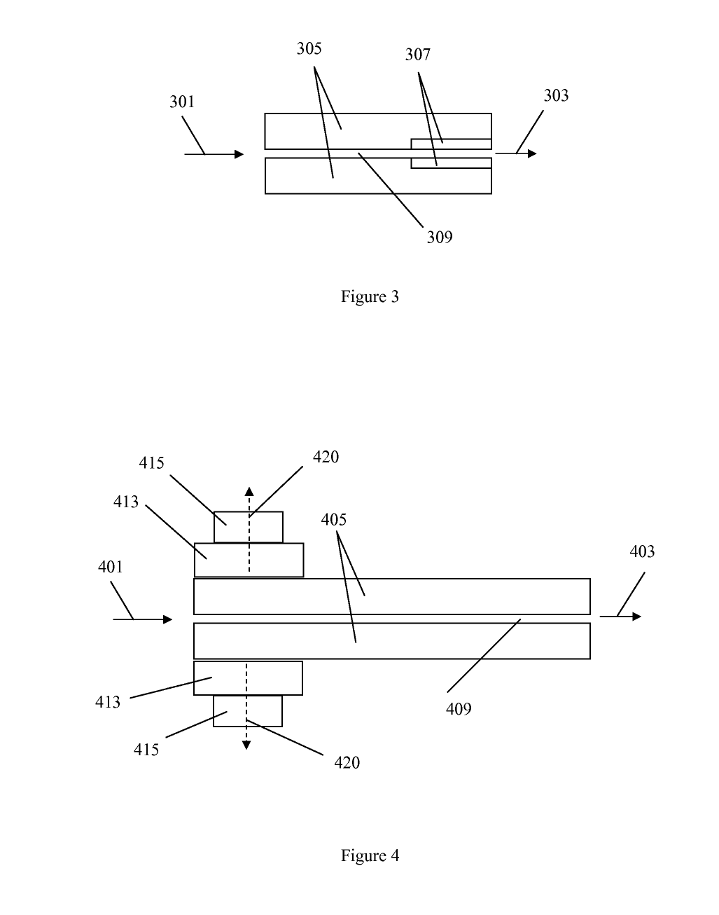

An embodiment of the present invention is to use a material on the spraying end of the capillary section that can accept an applied high voltage whereas the other portion of the sheath is made from a non-conductive material. FIG. 3 shows a non-limiting example of this type of electrospray ionization apparatus. The sample is introduced to one end of the electrosprayer 301 and ions form near the other end 303 of the electrosprayer. An electrically conductive material sheath 307 at the end of the spraying end of the capillary section and a electrically non-conductive material sheath 305 enclose the capillary section 309. High voltage for electrospray ionization could be applied to the conductive sheath 307

The material of the sheath 305 around the capillary section 309 as shown in FIG. 3 can be made from thermally conductive dielectric material, such as, but not limited to, Aluminium nitride (AIN), Boron nitride, Aluminium phosphide, Induim nitride, alumina, ceramic, quartz, glass, BeO, and the conductive material sheath 307 can be made from metals, alloys, metalloids, alkaline earth metals, lanthanides, actinides, and transition elements.

One aspect of the present invention is a method and apparatus to actively cooling the electrosprayer and surrounding components in order to keep the electrosprayer at a lower temperature than the heated chamber, in case of an IMS, the heated chamber is the desolvation of the drift tube. The method and apparatus of cooling limits the sample from crashing out (crystallizing) on the electrospray tip. The means to cool the electrosprayer, maybe through convection and/or conduction, but are not limited to only these.

Cooling the electrospray ionization through convection can be accomplished through natural convective heat transfer and/or forced convection. Convection is one of the major modes of heat transfer through the movement of molecules within liquids and gases. For example, by using forced convection the electrospray ionization can be cooled by using a fan or a pump. A capillary used for electrospray ionization can be externally cooled by applying a water-cooled jacket and/or an air-cooled jacket. The sheath can be directly cooled by a refrigerant such as liquid nitrogen flowing along the length of the sheath. The sheath can be cooled by forming a heat exchange between two liquids A & B flowing in opposite direction to each other.

Cooling the electrospray ionization through conduction can be accomplished through transferring the thermal energy through matter from a region of higher temperature to a region of lower temperature through direct contact. For example, electrons in a metal transfer the heat from one particle to another. A transmissive heat exchange element such as a heat sink can be used to cool the sheath.

A preferred embodiment of the present invention uses an AIN sheath 405 with a capillary section 409 that the sample travels from one end 401 through the section and forms ions in region 403 as shown in FIG. 4. A cooling means, a heat sink 413 in-conjunction with a fan 415 (in this particular example, the heat is moved in the direction of 420), is used to keep the temperature of the AIN sheath low. The AIN sheath is inside the chamber at elevated temperature. Due to the cooling means, the sample is electrosprayed without crashing out sample on the electrospray tip. Using the apparatus shown in FIG. 4, non-volatile samples that otherwise could not be analyzed can be analyzed by using this invention.

Another embodiment of the electrospray ionization apparatus has a capillary section, a sheath around the capillary section, and a means to transfer thermal energy from a region of higher temperature to a region of lower temperature. The region of higher temperature can be the sheath. The sheath can be made of aluminium nitride. A heat sink can be in contact with the sheath to transfer thermal energy away from the sheath. The heat sink can be coupled to a fan for transferring thermal energy from a region of higher temperature to a region of lower temperature. A heat exchanger can be actively cooled, in particular, by coupling the heat exchanger to a fan for transferring thermal energy.

Another embodiment of the present invention is an electrospray ionization method that supplies a sample to a electrosprayer wherein some of the sample is ionized and thermal energy is transferred from the electrosprayer to a heat exchanger through one or more contact points controlling the electrosprayer at a given temperature. The thermal energy can be transferred through heat conduction and/or by directly contacting the electrosprayer. Or it can be transferred through actively cooling a heat sink. In particular, the heat sink can be used in-conjunction with a fan. The electrospray ionization method can also include a sheath placed around the electrosprayer for maintaining a given temperature. In addition, the sheath could be in direct contact with the electrosprayer via one or more contact points. Also, the sheath could be in direct contact to the heat exchanger.

In variety of embodiments, in order to optimize heat transfer, the sheath can be made from one or more layers of metal or dielectric materials such as aluminium nitride, stainless steel, and nickel. The material with high thermal conductivity, such as the metals, can be maintained at a relative low temperature (e.g. 60° C.) in a high temperature environment (e.g. 250° C.) by rapidly removing heat from the material. In this invention, a heat exchanger is directly attached to the electrosprayer (or the sheath); as long as the heat transfer rate between the electrosprayer (or the sheath) and surrounding high temperature environment is slower than the cooling ability of the heat exchanger, the electrosprayer will be maintained at a lower temperature as required for normal operation. As high voltage is used in the electrospray ionization process, the high thermal conductivity material is preferred to be non-electrically conductive. In many embodiments, the aluminum nitride or other ceramics can be used for heat transfer. The ceramic materials have thermal conductivity similar to metal, such as nickel, but are dielectric materials. More than one layer of materials can be used to optimize the performance of the sheath structure. An outer layer of relatively low thermal conductive material such as stainless steel could be placed next to the high thermal conductive material, such as AlN, to limit the amount of heat that could be transferred to the sheath from the surrounding air. Thus, the device will have a lower overall heat loss (power requirement) for the same operation.

Yet another embodiment of the present invention is an electrospray ionization method which comprises: applying a potential to a capillary section, introducing a sample to the capillary section, producing ions from the capillary section, and transferring thermal energy from a region of higher temperature to a region of lower temperature. The transfer of thermal energy can be through convection and/or conduction. The transfer of thermal energy can be through directly contacting the capillary section. The transfer of thermal energy can be through a heat sink or a heat sink in-conjunction with a fan.

In various embodiments, the method and apparatus described for electrospray ionization can be applied to other ionization methods and instruments where temperature control in necessary; the method of actively pumping heat in or out for the ionization device can have a broad range of application for many analytical instruments. The method and apparatus is not necessary used for the cooling the ionization device, it could also be used to heat the device.

One embodiment of the apparatus comprises an ionization apparatus at one end of a thermal conductive media (the media can be solid, liquid, or gas); an active heating or cooling device at the other end of the media; the media serve as a heat pipe or bridge allowing the addition and/or removal of the heat to/from the ionization device, thus keep the ionization device at given temperature. An active heating/cooling device is a device that is used to intentionally add heat by incorporating a heater or intentionally removing heat by incorporate a heat sink. In contrast with a passive heating or cooling device that relies on natural heat exchange by exposing the object in a high or low temperature environment. AlN is ideal to be used as the media because of its good thermal conductivity but is a dielectric material.

In addition, a layer of low thermal conductivity material may be added to surface that is exposed to operating environment, thus heat transfer from the environment to the ionization device could limited. As a non-limiting example, a stainless steel layer or “cap” could be added to the AlN bridge (the media) 405, and the amount of heat need to be pumped by the active hearting/cooling device is reduced compared to bare AlN.

What is claimed is:

1. A electrospray ionization apparatus, comprising:
an electrosprayer wherein some of a sample that is supplied is ionized; and
a heat exchanger that is in direct contact to the electrosprayer via one or more contact points to transfer thermal energy controlling the electrosprayer at a given temperature.

2. The electrospray ionization apparatus of claim 1, further comprises a sheath placed around the electrosprayer;

3. The electrospray ionization apparatus of claim 2, wherein the electrosprayer is in direct contact with the sheath via one or more contact points.

4. The electrospray ionization apparatus of claim 2, wherein the sheath is in direct contact to the heat exchanger.

5. The electrospray ionization apparatus of claim 2, wherein the sheath is made of one or more layers of material.

6. The electrospray ionization apparatus of claim 5, wherein the layer of material is made of aluminium nitride.

7. The electrospray ionization apparatus of claim 5, wherein the layer of material is made of metal.

8. The electrospray ionization apparatus of claim 1, wherein electrosprayer is a capillary tube.

9. The electrospray ionization apparatus of claim 1, wherein electrosprayer is a pneumatic electrospray device comprising a capillary tube, an outer structure that allows delivering a nebulizing gas flow.

10. The electrospray ionization apparatus of claim 1, wherein the heat exchanger is actively cooled, in particular, is coupled to a fan for transferring thermal energy.

11. A electrospray ionization method, comprising:
supplying a sample to an electrosprayer wherein some of the sample is ionized; and
transferring thermal energy from the electrosprayer to a heat exchanger via one or more contact points controlling the electrosprayer at a given temperature.

12. The electrospray ionization method of claim 11, wherein the transferring thermal energy is through heat conduction.

13. The electrospray ionization method of claim 11, wherein the transferring thermal energy is through directly contacting the electrosprayer.

14. The electrospray ionization method of claim 11, wherein the transferring thermal energy through actively cooling a heat sink.

15. The electrospray ionization method of claim 11, further comprises using a sheath placed around the electrosprayer for maintaining a given temperature;

16. The electrospray ionization method of claim 15, wherein maintaining a given temperature is accomplished by placing the electrosprayer in direct contact with the sheath via one or more contact points.

17. The electrospray ionization method of claim 15, wherein maintaining a given temperature is accomplished by placing the sheath in direct contact to the heat exchanger.

18. The electrospray ionization method of claim 15, wherein making the sheath of one or more layers of metal or dielectric materials, in particular, the sheath is made of aluminium nitride, stainless steel, nickel, for optimized heat transfer.

19. The electrospray ionization method of claim 11, wherein transferring thermal energy through actively cooling a heat sink, in particular, the heat sink is in-conjunction with a fan.
